(19) United States
(12) Patent Application Publication
(10) Pub. No.: US 2025/0258421 A1
(43) Pub. Date: Aug. 14, 2025

(54) NONLINEAR PHOTONIC ELEMENTS FOR HYBRID PHOTONIC CIRCUITS

(71) Applicant: Milkshake Technology Inc., Menlo Park, CA (US)

(72) Inventors: Alireza Samani, Ottawa (CA); Bicky A. Marquez, Kingston (CA); Bhavin J. Shastri, Kingston (CA); Douglas H. Wightman, Kingston (CA)

(21) Appl. No.: 18/436,476

(22) Filed: Feb. 8, 2024

(51) Int. Cl. G02F 3/00

(52) U.S. Cl. CPC G02F 3/00

(57) ABSTRACT

A hybrid photonic circuit with one or more nonlinear photonic elements. The photonic circuit includes one or more photonic logic gate and one or more nonlinear photonic elements coupled to the one or more photonic logic gate. The one or more photonic logic gates receives one or more photonic input signals and generate one or more photonic intermediate output signals based at least in part on the one or more photonic input signals. The one or more nonlinear photonic elements receive the one or more photonic intermediate output signals and generate one or more photonic output signals through application of a nonlinear transfer function of the one or more nonlinear photonic elements to one or more amplitudes of the one or more photonic intermediate output signals.

### TECHNICAL FIELD

The present disclosure generally relates to a processor architecture and, more specifically, to nonlinear photonic elements for hybrid photonic circuits.

### BACKGROUND

Photonic hardware is favorable for applications requiring high bandwidth, low latency, and low switching energy for signal processing, data communications, and information processing (i.e., computing systems and operations). Recent innovations in silicon photonic fabrication have enabled the on-chip implementation of photonic circuits. This has opened a low-cost, high-precision, and scalable avenue for the development of photonic computing. Advances in photonic computing have demonstrated suitability for applications requiring high-bandwidth parallel processing, especially neural networks, offering higher speed and less energy consumption than equivalent networks implemented in digital and/or analog electronics.

However, different phases of optical signals (i.e., light signals) processed by a photonic logic gate can cause amplitude errors and/or phase errors at an output of the photonic logic gate. Furthermore, circuitry for photonic computing typically employs cascaded photonic logic gates, and the amplitude errors and/or phase errors can propagate and accumulate through photonic circuitry that includes cascaded photonic logic gates. Also, optical signals propagating through one or more photonic logic gates can suffer from degradations in signal quality.

Therefore, the practical photonic logic needs to fulfil requirements for cascadability and logic-level restoration.

### SUMMARY

Embodiments of the present disclosure are directed to nonlinear photonic elements used for realization of a hybrid photonic circuit that fulfils requirements for cascadability and logic-level restoration. The hybrid photonic circuit may include one or more photonic logic gates (one or more photonic logic elements or one or more photonic logic devices) having a first set of one or more inputs and a first set of one or more outputs, and one or more nonlinear photonic elements having a second set of one or more inputs and a second set of one or more outputs. The first set of one or more inputs is configured to receive one or more photonic input signals, and the one or more photonic logic gates are configured to generate one or more photonic intermediate output signals at the first set of one or more outputs based at least in part on the one or more photonic input signals. The second set of one or more inputs is coupled to the first set of one or more outputs and configured to receive the one or more photonic intermediate output signals. The one or more nonlinear photonic elements are configured to generate one or more photonic output signals at the second set of one or more outputs through application of a nonlinear transfer function of the one or more nonlinear photonic elements to one or more amplitudes of the one or more photonic intermediate output signals.

Embodiments of the present disclosure are further directed to a non-transitory computer-readable storage medium comprising stored instructions. The instructions, when executed by at least one processor, cause the at least one processor to execute operations. The operations are comprised to instruct one or more photonic logic gates of a photonic circuit to receive one or more photonic input signals at a first set of one or more inputs; instruct the one or more photonic logic gates to generate one or more photonic intermediate output signals at a first set of one or more outputs based at least in part on the one or more photonic input signals; instruct one or more nonlinear photonic elements of the photonic circuit to receive the one or more photonic intermediate output signals at a second set of one or more inputs coupled to the first set of one or more outputs; and instruct the one or more nonlinear photonic elements to generate one or more photonic output signals at a second set of one or more outputs through application of a nonlinear transfer function of the one or more nonlinear photonic elements to one or more amplitudes of the one or more photonic intermediate output signals. The non-transitory computer-readable storage medium can be a digital storage medium, an analog storage medium, an optical storage medium, some other type of storage medium, or some combination thereof. The at least one processor can be an optical processor, an electronic processor (e.g., central processing unit (CPU) processor, machine learning (ML) processor, graphics processing unit (GPU) processor), some other type of processor, or some combination thereof.

Embodiments of the present disclosure are further directed to a method for operating a photonic circuit with one or more nonlinear photonic elements. The method comprises: receiving one or more photonic input signals at a first set of one or more inputs of one or more photonic logic elements of a photonic circuit; generating, by the one or more photonic logic elements at a first set of one or more outputs, one or more photonic intermediate output signals based at least in part on the one or more photonic input signals; receiving the one or more photonic intermediate output signals at a second set of one or more inputs of one or more nonlinear photonic elements of the photonic circuit, the second set of one or more inputs coupled to the first set of one or more outputs; and generating, by the one or more nonlinear photonic elements at a second set of one or more outputs, one or more photonic output signals through application of a nonlinear transfer function of the one or more nonlinear photonic elements to one or more amplitudes of the one or more photonic intermediate output signals

### BRIEF DESCRIPTION OF THE DRAWINGS

FIG. 1 illustrates an example photonic circuit that includes a cascading connection of a photonic logic gate and a nonlinear photonic circuit, in accordance with some embodiments.

FIG. 2A illustrates examples of different configurations of a nonlinear photonic circuit, in accordance with some embodiments.

FIG. 2B illustrates an example graph of a transfer function of a configuration of the nonlinear photonic circuit in FIG. 2A, in accordance with some embodiments.

FIG. 3A illustrates a first example graph of a transfer function of a nonlinear photonic circuit, in accordance with some embodiments.

FIG. 3B illustrates a second example graph of a transfer function of a nonlinear photonic circuit, in accordance with some embodiments.

FIG. 3C illustrates a first example graph of a transfer function of a nonlinear photonic circuit, in accordance with some embodiments.

FIG. 3D illustrates a second example graph of a transfer function of a nonlinear photonic circuit, in accordance with some embodiments.

FIG. 4A illustrates an example graph of a gain function of a nonlinear photonic circuit, in accordance with some embodiments.

FIG. 4B illustrates an example graph of an input power applied over time to the nonlinear photonic circuit having the gain function of FIG. 4A, in accordance with some embodiments.

FIG. 4C illustrates an example graph of an output power generated over time by the nonlinear photonic circuit having the gain function of FIG. 4A, in accordance with some embodiments.

FIG. 5A illustrates another example graph of a gain function of a nonlinear photonic circuit, in accordance with some embodiments.

FIG. 5B illustrates an example graph of an input power applied over time to the nonlinear photonic circuit having the gain function of FIG. 5A, in accordance with some embodiments.

FIG. 5C illustrates an example graph of an output power generated over time by the nonlinear photonic circuit having the gain function of FIG. 5A, in accordance with some embodiments.

FIG. 6 is a flowchart illustrating an example method for operating a photonic circuit as a hybrid photonic gate, in accordance with some embodiments.

The figures depict embodiments of the present disclosure for purposes of illustration only. One skilled in the art will readily recognize from the following description that alternative embodiments of the structures and methods illustrated herein can be employed without departing from the principles or benefits touted by the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that can be employed without departing from the principles of what is claimed.

Reference will now be made in detail to several embodiments, examples of which are illustrated in the accompanying figures. It is noted that wherever practicable, similar or like reference numbers can be used in the figures and can indicate similar or like functionality. The figures depict embodiments of the disclosed system (or method) for illustration only. One skilled in the art will readily recognize from the following description that alternative embodiments of the structures and methods illustrated herein can be employed without departing from the principles described herein.

Embodiments of the present disclosure are directed to a cascadable hybrid photonic circuit that includes one or more linear photonic elements and one or more nonlinear photonic elements for correction of amplitude and/or phase errors. The one or more nonlinear photonic elements may include one or more saturable absorbers, one or more semiconductor optical amplifiers (SOAs), a cascade of one or more saturable absorbers and one or more SOAs, some other type of nonlinear photonic element, or some combination thereof. By employing a specific combination of saturable absorbers and/or SOAs, different nonlinear transfer functions can be realized within hybrid photonic circuits making them suitable for performing different logic operations with reduced levels of phase noise and/or amplitude noise.

Photonic Circuit with Nonlinear Component

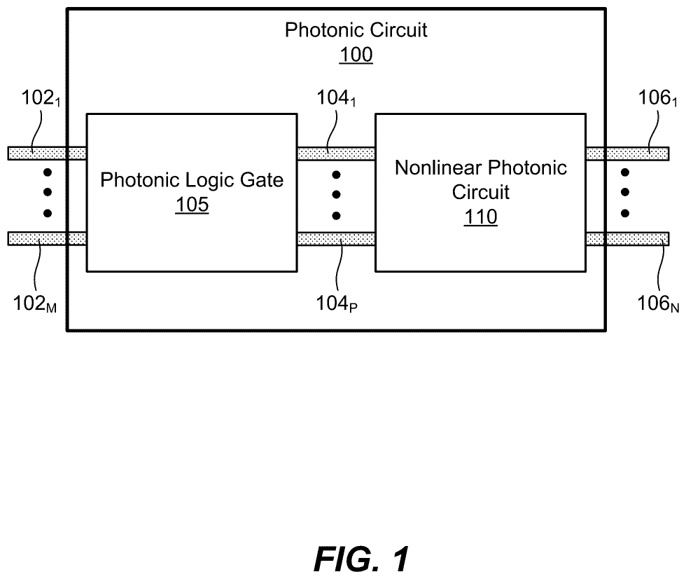

FIG. 1 illustrates an example photonic circuit 100, in accordance with some embodiments. The photonic circuit 100 may receive one or more photonic input signal 102₁, . . . , 102_{M} (e.g., M≥1) at a set of one or more input ports of the photonic circuit 100 and generate one or more photonic output signals 106₁, . . . , 106_{N} (e.g., N≥1) at a set of one or more output ports of the photonic circuit 100. The one or more photonic input signals 102₁, . . . , 102_{M} may be generated by one or more lasers coupled to the set of one or more input ports of the photonic circuit 100. Alternatively, the one or more photonic input signals 102₁, . . . , 102_{M} may be generated by one or more photonic circuits having one or more output ports coupled to the set of one or more input ports of the photonic circuit 100. Each of one or more photonic input signals 102₁, . . . , 102_{M} may be a light signal of corresponding input amplitudes (that each corresponds to logical “1” or logical “0”), corresponding input phases and/or corresponding input modes (i.e., input light spatial distribution and/or input wavelengths) injected into each of the one or more input ports of the photonic circuit 100. In one or more embodiments, at least one of the one or more photonic input signals 102₁, . . . , 102_{M} is a bias signal having a constant amplitude over time.

The photonic circuit 100 may include a cascading connection of a photonic logic gate 105 and a nonlinear photonic circuit 110. A set of one or more input ports of the photonic logic gate 105 may be coupled to the set of one or more input ports of the photonic circuit 100, and a set of one or output ports of the photonic logic gate 105 may be coupled to a set of one or more input ports of the nonlinear photonic circuit 110. A set of one or more output ports of the nonlinear photonic circuit 110 may be coupled to the set of one or more output ports of the photonic circuit 100. The photonic circuit 100 may include fewer or additional components not shown in FIG. 1, such as, but not limited to, phase shifters for compensation of fabrication variations, linear photonic amplifiers, photonic attenuators, and/or photonic amplitude thresholders.

The photonic logic gate 105 (or photonic logic element or photonic logic device) may be a photonic circuit that includes a set of one or more photonic elements such as, but not limited to, one or more beam splitters, one or more photonic combiners, one or more phase shifters, one or more photonic modulators, one or more delay lines, etc. that manipulate photonic signals input to the photonic logic gate 105 and generate photonic output signals. The photonic logic gate 105 may receive, at one or more input ports, the one or more photonic input signals 102₁, . . . , 102_{M}. The set of one or more input ports of the photonic logic gate 105 may represent, e.g., a set of waveguides, a set of waveguide polarizations, a set of waveguide modes, a set of light wavelengths, etc. The set of one or more input ports of the photonic logic gate 105 may also represent the one or more input ports of the photonic circuit 100. The photonic logic gate 105 may generate one or more photonic signals 104₁, . . . 104_{P} (e.g., P≥1) based on the one or more photonic input signals 102₁, . . . , 102_{M}. The photonic logic gate 105 may include one or more linear photonic elements. The one or more photonic signals 104₁, . . . 104_{P} generated by the photonic logic gate 105 may be output at one or more output ports of the photonic logic gate 105. The set of one or more output ports of the photonic logic gate 105 may represent, e.g., a set of waveguides, a set of waveguide polarizations, a set of waveguide modes, a set of light wavelengths, one or more signals radiated by the photonic logic gate 105, etc. The photonic logic gate 105 may pass the one or more photonic signals 104₁, . . . 104_{P} to the nonlinear photonic circuit 110.

The nonlinear photonic circuit 110 may receive, at one or more input ports, the one or more photonic signals 104₁, . . . 104_{P}. The set of one or more input ports of the nonlinear photonic circuit 110 may represent, e.g., a set of waveguides, a set of waveguide polarizations, a set of waveguide modes, a set of light wavelengths, etc. The nonlinear photonic circuit 110 may generate the one or more photonic output signals 106₁, . . . , 106_{N} through application of a nonlinear transfer function to the one or more photonic signals 104₁, . . . , 104_{P}. Given that the photonic logic gate 105 may include only one or more linear photonic elements, the one or more photonic signals 104₁, . . . 104_{P} generated by the photonic logic gate 105 may have one or more accumulative errors (e.g., one or more phase errors, one or more amplitude errors, one or more mode errors, one or more wavelength errors, one or more bit-errors, some other type of error, or some combination thereof). The nonlinear photonic circuit 110 coupled to the set of one or more output ports of the photonic logic gate 105 may correct the one or more accumulative errors in the one or more photonic signals 104₁, . . . 104_{P}, i.e., the one or more photonic output signals 106₁, . . . , 106_{N} generated by the nonlinear photonic circuit 110 may be photonic signals with restored logic levels.

An operating regime of the nonlinear photonic circuit 110 may depend on a level of each amplitude of the one or more photonic signals 104₁, . . . , 104_{P}. The nonlinear photonic circuit 110 may saturate or attenuate one or more amplitudes of the one or more photonic signals 104₁, . . . , 104_{P} when operating in one or more operating regimes that are typically referred to as “nonlinear operating regime(s)”. Otherwise, the nonlinear photonic circuit 110 may operate in an operating regime typically referred to as a “linear operating regime” when the nonlinear photonic circuit 110 applies a transfer gain of a “linear region” of the nonlinear transfer function to one or more amplitudes of the one or more photonic signals 104₁, . . . , 104_{P} when generating one or more amplitudes of the one or more photonic output signals 106₁, . . . , 106_{N}.

The nonlinear photonic circuit 110 may be implemented as one or more all-optical amplitude thresholders or electro-optical amplitude thresholders. An all-optical amplitude thresholder or electro-optical amplitude thresholders can be implemented with a variety of approaches in integrated or free-space, and variants or combinations thereof, including but not limited to a resonator-based device or circuit, a saturable absorber including based on graphene, MoS2 or other 2D materials, carbon nanotube, dye, unpumped gain medium, saturable semiconductor cavity laser mirror (i.e., SESAM), or a semiconductor absorber (e.g., quantum dots semiconductor optical amplifier (SOA), ion-implanted, reverse-biased or unpumped semiconductor, etc.), or artificial saturable absorber (e.g., Kerr lensing, nonlinear polarization rotation, fiber loop mirror, etc.). The nonlinear photonic circuit 110 implemented as the one or more all-optical amplitude thresholders or electro-optical amplitude thresholders may block light signals having intensity levels below a threshold value and propagate light signals having intensity levels above the threshold value. Furthermore, the nonlinear photonic circuit 110 may amplify an intensity level in a thresholded signal by applying a specific gain to further increase a contrast of the thresholded signal and compensate for any loss due to light absorption, e.g., when a saturable absorber is utilized as an amplitude thresholder to generate the thresholded signal.

The one or more photonic output signals 106₁, . . . 106_{N} generated by the nonlinear photonic circuit 110 may be output at one or more output ports of the nonlinear photonic circuit 110. The set of one or more output ports of the nonlinear photonic circuit 110 may represent, e.g., a set of waveguides, a set of waveguide polarizations, a set of waveguide modes, a set of light wavelengths, one or more signals radiated by the nonlinear photonic circuit 110, etc. The set of one or more output ports of the nonlinear photonic circuit 110 may also represent the set of one or more output ports of the photonic circuit 100. The one or more photonic output signals 106₁, . . . 106_{N} generated by the cascading connection of the photonic logic gate 105 and the nonlinear photonic circuit 110 may be one or more corrected photonic signals with restored logic levels that represent a result of a logic function of the one or more photonic input signals 102₁, . . . , 102_{M}. Note that the one or more photonic output signals 106₁, . . . 106_{N} may feature a lower level of amplitude noise and/or phase noise in comparison with the one or more photonic signals 104₁, . . . , 104_{P} generated by the photonic logic gate 105. The specific logic function performed by the cascading connection of the photonic logic gate 105 and the nonlinear photonic circuit 110 may depend (e.g., for a fixed structured of the photonic logic gate 105) on a specific structure and transfer function of the nonlinear photonic circuit 110. The nonlinear photonic circuit 110 may pass the one or more corrected photonic output signals 106₁, . . . , 106_{N} to one or more other photonic circuits (not shown in FIG. 1).

It should be noted that all photonic signals within the photonic circuit 100 (i.e., photonic signals 102₁, . . . , 102_{M}, photonic signals 104₁, . . . , 104_{P}, and photonic signals 106₁, . . . , 106_{N}) may be passed to corresponding photonic components of the photonic circuit 100 via silicon waveguides. Thus, all connections between photonic components of the photonic circuit 100 may be implemented as silicon waveguides. The photonic logic gate 105 may be implemented using silicon photonic circuits. The nonlinear photonic circuit 110 may be implemented in a III-V platform containing an alloy composed of semiconductors from groups III and V in the periodic table (e.g., InP, InAs, GaAs, GaN, and InSb) using a saturated absorber, SOA, saturated gain, some other type of amplitude thresholder, or some combination thereof. In such cases, the nonlinear photonic circuit 110 may be heterogeneously integrated within the photonic circuit 100. Alternatively, the nonlinear photonic circuit 110 may be implemented with electro-optical devices such as photodetectors, modulators, complementary metal-oxide-semiconductor transimpedance amplifiers (CMOS TIAs), and any other element that improves the design. In such cases, the nonlinear photonic circuit 110 may be CMOS monolithically integrated within the photonic circuit 100. Alternatively or additionally, the nonlinear photonic circuit 110 may also be fiber attached, micro-transfer printed, flip-chipped, optically and/or electronically wire-bonded to other components of the photonic circuit 100 and other photonic circuits coupled to outputs of the photonic circuit 100.

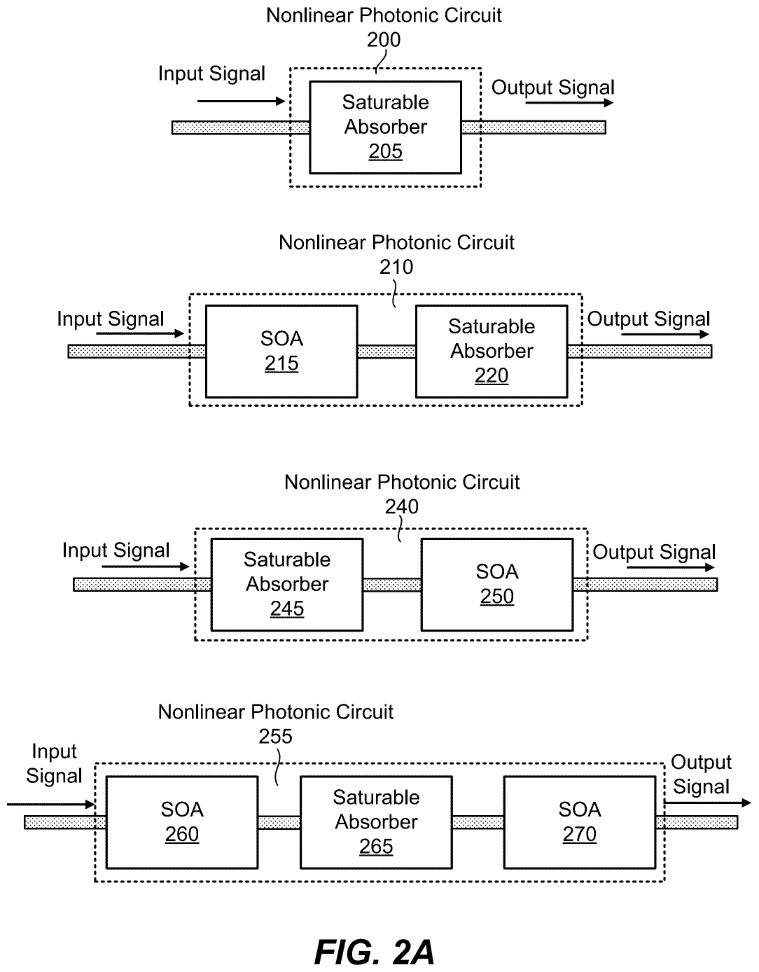

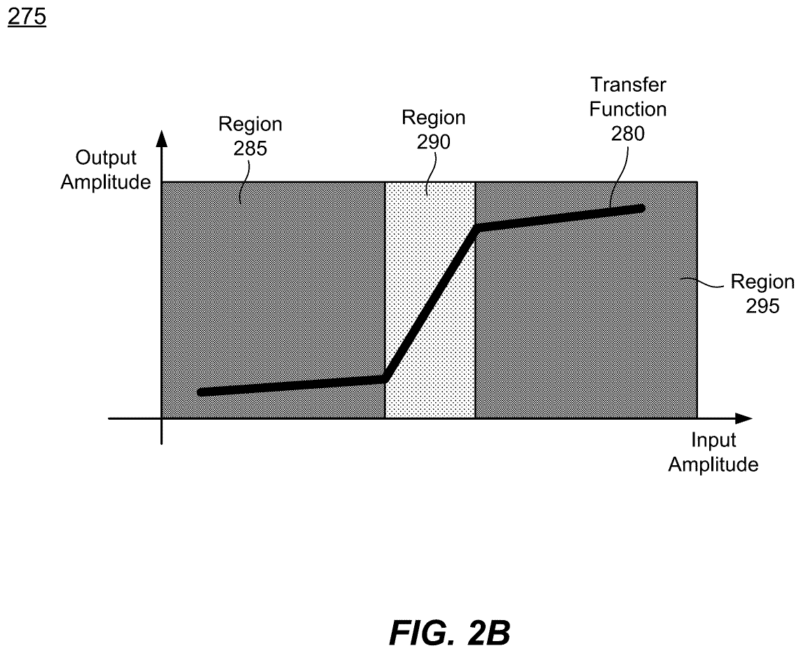

More details about a structure, operating regimes, and transfer functions of the nonlinear photonic circuit 110 are described in relation to FIGS. 2A through 5B.

### Transfer Functions and Configurations of Nonlinear Photonic Components

FIG. 2A illustrates examples of different configurations of the nonlinear photonic circuit 110, in accordance with some embodiments. Each configuration of the nonlinear photonic circuit 110 in FIG. 2A may feature a corresponding nonlinear transfer function having a same general piece-wise (e.g., sigmoid function) representation (e.g., as shown in FIG. 2B). Although FIG. 2A shows various different configurations of the nonlinear photonic circuit 110, it should be understood that some other configurations of the nonlinear photonic circuit 110 that are not shown in FIG. 2A are possible.

A nonlinear photonic circuit 200 in FIG. 2A may include a single saturable absorber 205. Alternatively, instead of the single saturable absorber 205, the nonlinear photonic circuit 200 may include a single SOA-based amplitude thresholder (referred to as “SOA” in FIG. 2A). The nonlinear photonic circuit 200 may be an embodiment of the nonlinear photonic circuit 110.

A nonlinear photonic circuit 210 in FIG. 2A may include a SOA 215 and a saturable absorber 220, where an input port of the saturable absorber 220 is coupled to an output port of the SOA 215. In such case, the SOA 215 may operate as an amplifier to boost power of the input signal so that the saturable absorber 220 can operate as an amplitude thresholder. Thus, the SOA 215 may operate in a linear operating regime and may not operate as an amplitude thresholder. The nonlinear photonic circuit 210 may be an embodiment of the nonlinear photonic circuit 110.

A nonlinear photonic circuit 240 in FIG. 2A may include a saturable absorber 245 and a SOA 250, where an input port of the SOA 250 is coupled to an output port of the saturable absorber 245. In such case, the SOA 250 may operate as an amplifier to boost power of a photonic signal generated by the saturable absorber 245, e.g., to compensate for any loss of signal intensity (i.e., power loss) caused by the saturable absorber 245. Thus, the SOA 250 may operate in a linear operating regime and may not operate as an amplitude thresholder. The nonlinear photonic circuit 240 may be an embodiment of the nonlinear photonic circuit 110.

A nonlinear photonic circuit 255 in FIG. 2A may include a first SOA 260, a saturable absorber 265 and a second SOA 270, where an input port of the saturable absorber 265 is coupled to an output port of the first SOA 260 and an input port of the second SOA 270 is coupled to an output port of the saturable absorber 265. In such case, the first SOA 260 may operate as an amplifier to boost power of the input signal so that the saturable absorber 265 can operate as an amplitude thresholder. Thus, the first SOA 260 may operate in a linear operating regime and may not operate as an amplitude thresholder. Similarly, the second SOA 270 may operate as an amplifier to boost power of a photonic signal generated by the saturable absorber 265, e.g., to compensate for any loss of signal intensity (i.e., power loss) caused by the saturable absorber 265. Thus, the second SOA 270 may operate in a linear operating regime and may not operate as an amplitude thresholder. The nonlinear photonic circuit 255 may be an embodiment of the nonlinear photonic circuit 110.

FIG. 2B illustrates an example graph 275 of a piece-wise transfer function 280 of a configuration of a nonlinear photonic circuit in FIG. 2A, in accordance with some embodiments. The configuration of the nonlinear photonic circuit having the transfer function represented by the piece-wise transfer function 280 may operate in a region 285 associated with a first operating regime, in a region 290 associated with a second operating regime, or in a region 295 associated with a third operating regime, which depends on an amplitude level of a photonic signal that is input into the corresponding configuration of the nonlinear photonic circuit in FIG. 2A (i.e., on a level of the “input amplitude”). In some embodiments, the regions 285 and 295 are approximately nonlinear regions of the piece-wise transfer function 280, and the region 290 is approximately linear region of the piece-wise transfer function 280.

When the nonlinear photonic circuit operates in the region 285, an amplitude of a photonic signal output by the nonlinear photonic circuit (i.e., “output amplitude”) may be saturated to a first saturation level. When the nonlinear photonic circuit operates in the region 295, the output amplitude may be saturated to a second saturation level that is higher than the first saturation level. When the nonlinear photonic circuit operates in the region 290, the output amplitude may not be saturated but instead determined based on a gain (i.e., slope) of the piece-wise transfer function 280 in the region 290. For some configurations of the nonlinear photonic circuit in FIG. 2A, the piece-wise transfer function 280 may only include the regions 285 and 290 (i.e., the region 295 may not be present) or may only include the regions 290 and 295 (i.e., the region 285 may not be present).

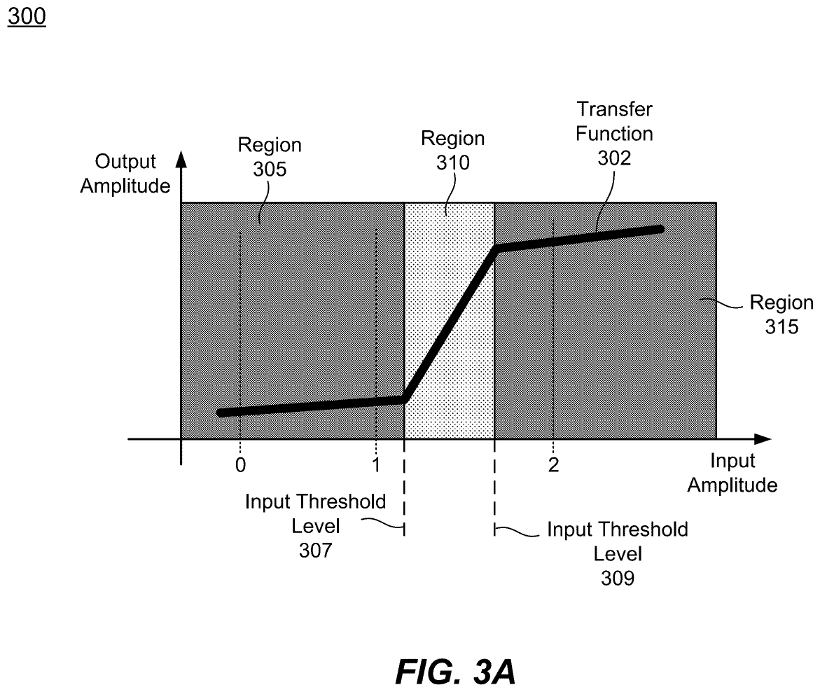

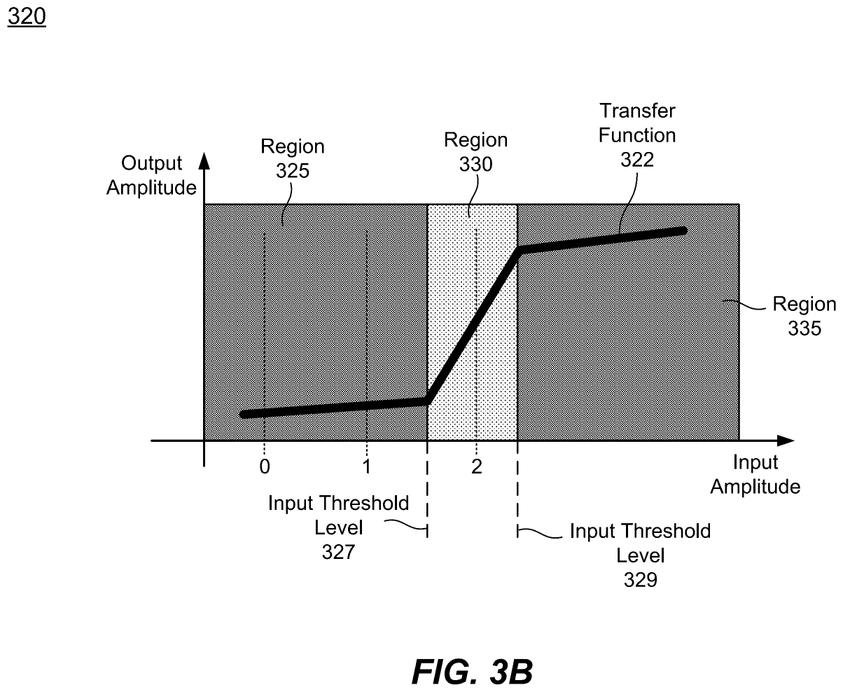

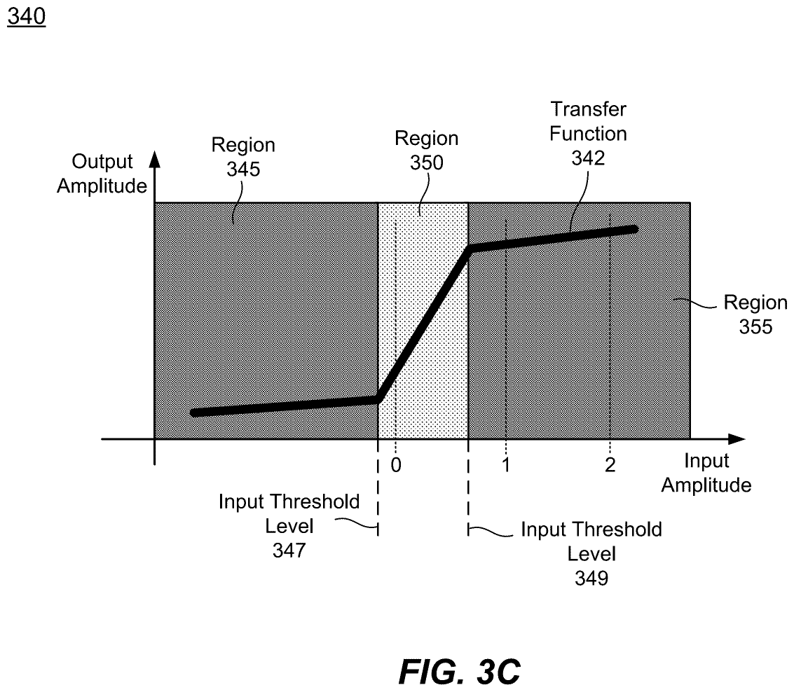

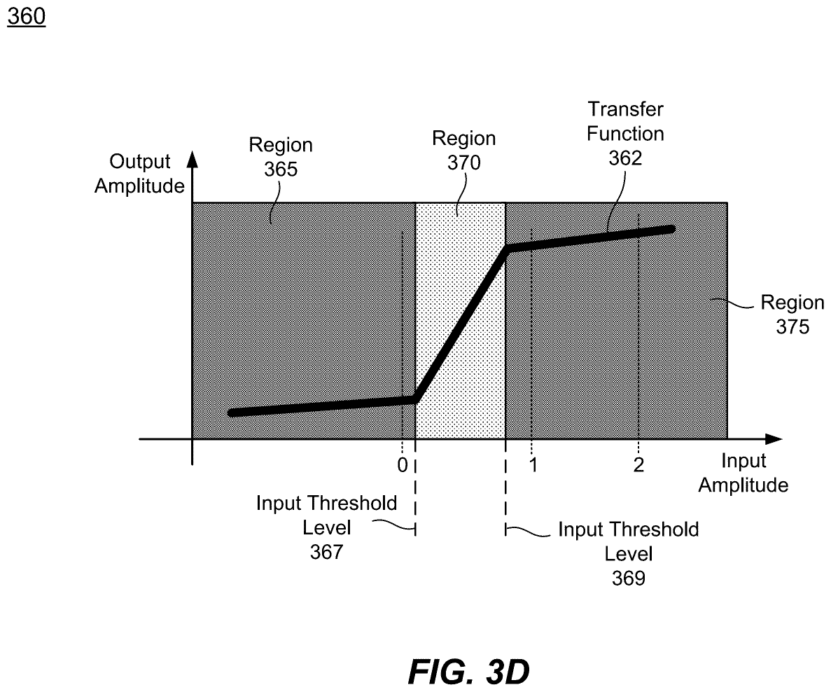

Each configuration of the nonlinear photonic circuit in FIG. 2A (i.e., each of the nonlinear photonic circuits 200, 210, 240, 255) may feature a different piece-wise transfer function 280. Each of the nonlinear photonic circuits 200, 210, 240, 255 may feature a piece-wise transfer function 280 with a unique set of slopes. Additionally, or alternatively, each of the nonlinear photonic circuits 200, 210, 240, 255 may feature a different region 285, a different region 290 and/or a different region 295. This is because each of the nonlinear photonic circuits 200, 210, 240, 255 may require a different range of input amplitudes to operate in a corresponding region 285, 290, 295. Additionally, or alternatively, each of the nonlinear photonic circuits 200, 210, 240, 255 may feature different saturation levels when operating in the region 285 and/or the region 295. Examples of different transfer functions of the nonlinear photonic circuit 110 that require different ranges of input amplitudes for operating in a corresponding region 285, 290, 295 are shown in FIGS. 3A-3D.

FIG. 3A illustrates an example graph 300 of a transfer function 302 of the nonlinear photonic circuit 110, in accordance with some embodiments. The transfer function 302 may be an embodiment of the nonlinear transfer function 280. The nonlinear photonic circuit 110 may operate in a region 305 of the transfer function 302 (e.g., “first saturation region” or “first nonlinear region”) when an “input amplitude” provided to the nonlinear photonic circuit 110 (e.g., amplitude of the one or more photonic signals 104₁, . . . , 104_{P}) is less than or equal to an input threshold level 307. In such a case, the nonlinear photonic circuit 110 may saturate the input amplitude that is less than the input threshold level 307 (e.g., input amplitude of level “0” or level “1”) into a first output saturation level. The nonlinear photonic circuit 110 may operate in a region 315 of the transfer function 302 (e.g., “second saturation region” or “second nonlinear region”) when an “input amplitude” provided to the nonlinear photonic circuit 110 (e.g., amplitude of the one or more photonic signals 104₁, . . . , 104_{P}) is greater than or equal to an input threshold level 309. In such a case, the nonlinear photonic circuit 110 may saturate the input amplitude (e.g., input amplitude of level “2”) into a second output saturation level that is larger than the first output saturation level. When the “input amplitude” is smaller than the input threshold level 309 but greater than the input threshold level 307, an “output amplitude” (e.g., amplitude of the one or more photonic output signals 106₁, . . . , 106_{N}) may not be saturated but instead processed by a transfer gain (i.e., slope) of a region 310 of the transfer function 302 (e.g., “linear region”) in which the nonlinear photonic circuit 110 operates.

FIG. 3B illustrates an example graph 320 of a transfer function 322 of the nonlinear photonic circuit 110, in accordance with some embodiments. The transfer function 322 may be an embodiment of the nonlinear transfer function 280. The nonlinear photonic circuit 110 may operate in a region 325 of the transfer function 322 (e.g., “first saturation region” or “first nonlinear region”) when an “input amplitude” provided to the nonlinear photonic circuit 110 (e.g., amplitude of the one or more photonic signals 104₁, . . . , 104_{P}) is less than or equal to an input threshold level 327. In such a case, the nonlinear photonic circuit 110 may saturate the input amplitude that is less than the input threshold level 327 (e.g., input amplitude of level “0” or level “1”) into a first output saturation level. The nonlinear photonic circuit 110 may operate in a region 335 of the transfer function 322 (e.g., “second saturation region” or “second nonlinear region”) when an “input amplitude” provided to the nonlinear photonic circuit 110 (e.g., amplitude of the one or more photonic signals 104₁, . . . , 104_{P}) is greater than or equal to an input threshold level 329. In such a case, the nonlinear photonic circuit 110 may saturate the input amplitude into a second output saturation level that is larger than the first output saturation level. When the “input amplitude” is smaller than the input threshold level 329 but greater than the input threshold level 327, an “output amplitude” (e.g., amplitude of the one or more photonic output signals 106₁, . . . , 106_{N}) may not be saturated but instead processed by a transfer gain (i.e., slope) of a region 330 of the transfer function 322 (e.g., “linear region”) in which the nonlinear photonic circuit 110 operates. For example, the nonlinear photonic circuit 110 may process the input amplitude of level “2” by applying the transfer gain of the region 330 when generating the “output amplitude”

FIG. 3C illustrates an example graph 340 of a transfer function 342 of the nonlinear photonic circuit 110, in accordance with some embodiments. The transfer function 342 may be an embodiment of the nonlinear transfer function 280. The nonlinear photonic circuit 110 may operate in a region 345 of the transfer function 342 (e.g., “first saturation region” or “first nonlinear region”) when an “input amplitude” provided to the nonlinear photonic circuit 110 (e.g., amplitude of the one or more photonic signals 104₁, . . . , 104_{P}) is less than or equal to an input threshold level 347. In such a case, the nonlinear photonic circuit 110 may saturate the input amplitude into a first output saturation level. The nonlinear photonic circuit 110 may operate in a region 355 of the transfer function 342 (e.g., “second saturation region” or “second nonlinear region”) when an “input amplitude” provided to the nonlinear photonic circuit 110 (e.g., amplitude of the one or more photonic signals 104₁, . . . , 104_{P}) is greater than or equal to an input threshold level 349. In such a case, the nonlinear photonic circuit 110 may saturate the input amplitude that is greater than the input threshold level 349 (i.e., the input amplitude of level “1” or level “2”) into a second output saturation level that is larger than the first output saturation level. When the “input amplitude” is smaller than the input threshold level 349 but greater than the input threshold level 347, an “output amplitude” (e.g., amplitude of the one or more photonic output signals 106₁, . . . , 106_{N}) may not be saturated but instead processed by a transfer gain (i.e., slope) of a region 350 of the transfer function 342 (e.g., “linear region”) in which the nonlinear photonic circuit 110 operates. For example, the nonlinear photonic circuit 110 may process the input amplitude of level “0” by applying the transfer gain of the region 350 when generating the “output amplitude”.

FIG. 3D illustrates an example graph 360 of a transfer function 362 of the nonlinear photonic circuit 110, in accordance with some embodiments. The transfer function 362 may be an embodiment of the nonlinear transfer function 280. The nonlinear photonic circuit 110 may operate in a region 365 of the transfer function 322 (e.g., “first saturation region” or “first nonlinear region”) when an “input amplitude” provided to the nonlinear photonic circuit 110 (e.g., amplitude of the one or more photonic signals 104₁, . . . , 104_{P}) is less than or equal to an input threshold level 367. In such a case, the nonlinear photonic circuit 110 may saturate the input amplitude that is less than the input threshold level 367 (e.g., the input amplitude of level “0”) into a first output saturation level. The nonlinear photonic circuit 110 may operate in a region 375 of the transfer function 362 (e.g., “second saturation region” or “second nonlinear region”) when an “input amplitude” provided to the nonlinear photonic circuit 110 (e.g., amplitude of the one or more photonic signals 104₁, . . . , 104_{P}) is greater than or equal to an input threshold level 369. In such a case, the nonlinear photonic circuit 110 may saturate the input amplitude that is greater than the input threshold level 369 (i.e., the input amplitude of level “1” or level “2”) into a second output saturation level that is larger than the first output saturation level. When the “input amplitude” is smaller than the input threshold level 369 but greater than the input threshold level 367, an “output amplitude” (e.g., amplitude of the one or more photonic output signals 106₁, . . . , 106_{N}) may not be saturated but instead processed by a transfer gain (i.e., slope) of a region 370 of the transfer function 362 (e.g., “linear region”) in which the nonlinear photonic circuit 110 operates.

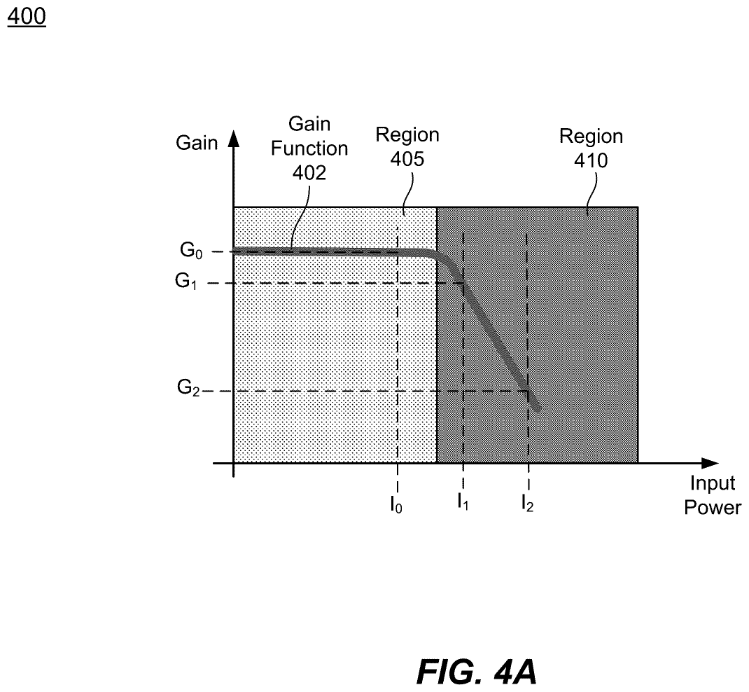

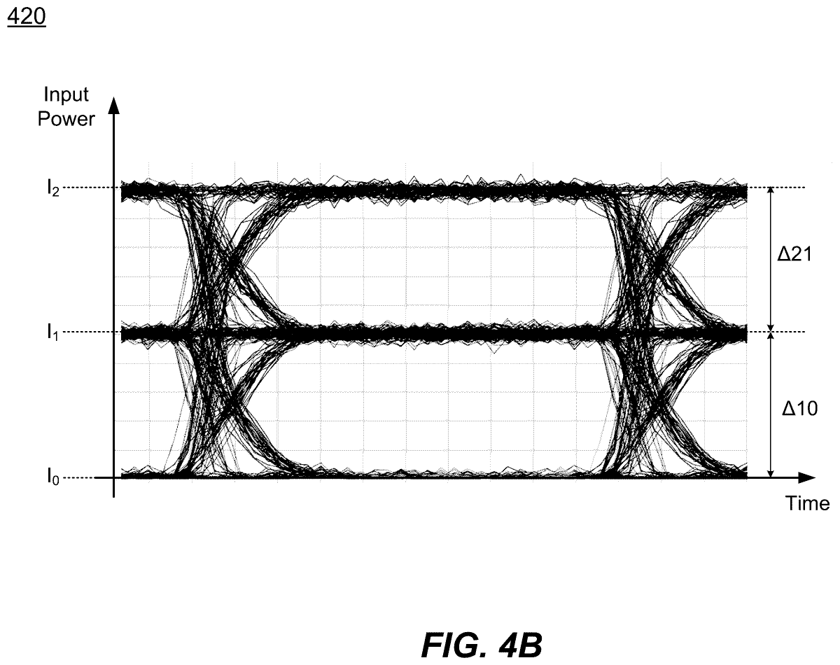

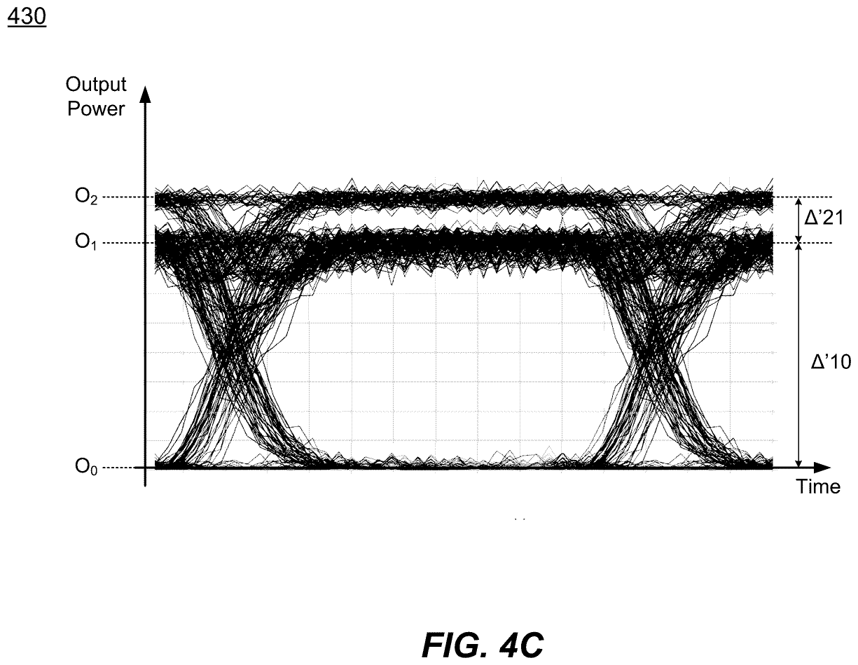

FIG. 4A illustrates an example graph 400 of a gain function 402 of the nonlinear photonic circuit 110, in accordance with some embodiments. The gain function 402 defines the relation between an input power of the nonlinear photonic circuit 110 and a gain applied by the nonlinear photonic circuit 110 to amplitudes of the one or more photonic signals 104₁, . . . , 104_{P} input to the nonlinear photonic circuit 110 (i.e., “input amplitudes”) to generate amplitudes of the one or more photonic output signals 106₁, . . . , 106_{N} (i.e., “output amplitudes”). It can be observed from the graph 400 that a gain applied by the nonlinear photonic circuit 110 differs for different operating regions (i.e., different operating regimes) of the nonlinear photonic circuit 110.

When the nonlinear photonic circuit 110 operates in a region 405 (i.e., “linear operating region” or “linear operating regime”), the gain is approximately constant. Thus, when any of the one or more photonic signals 104₁, . . . , 104_{P} is applied to the nonlinear photonic circuit 110 having an input amplitude with an input power of I₀ that falls within the region 405, an approximately constant gain of G₀ is applied to each input amplitude. When the nonlinear photonic circuit 110 operates in a region 410 (i.e., “saturation region”, “nonlinear operating region” or “nonlinear operating regime”), the gain function 402 is a decreasing function of the input power. Thus, when the nonlinear photonic circuit 110 operates in the region 410, a first gain of G₁ that is less than or equal to G₀ is applied to an input amplitude with an input power of I₁, and a second gain of G₂ is applied to an input amplitude with an input power of I₂, where G₁>G₂ for I₁<I₂. It can be observed that when the nonlinear photonic circuit 110 operates in the region 410, the gain applied to the input amplitudes is suppressed, and, thus, output amplitudes of the one or more photonic output signals 106₁, . . . , 106_{N} generated by the nonlinear photonic circuit 110 are saturated. And the gain applied by the nonlinear photonic circuit 110 is more suppressed in the operating region 410 for higher values of the input power.

FIG. 4B illustrates an example graph 420 of an input power applied over time to the nonlinear photonic circuit 110 having the gain function 402, in accordance with some embodiments. The graph 420 shows different input power values that are proportional to input amplitude values applied over time to the nonlinear photonic circuit 110 while operating the nonlinear photonic circuit 110 in different operating regimes (or different regions, such as the regions 405 and 410 of FIG. 4A). Specifically, the graph 420 shows the input power values having three different values of I₀, I₁ and I₂ that may correspond respectively to the input power values I₀, I₁ and I₂ in FIG. 4A. Furthermore, the input power values I₀, I₁ and I₂ may be also proportional respectively to the input amplitudes of levels “0”, “1” and “2” in FIG. 3C and FIG. 3D. The value Δ10 in FIG. 4B represents a difference between the input power value of I₁ and the input power value of I₀, i.e., Δ10=I₁−I₀. Similarly, the value Δ21 in FIG. 4B represents a difference between the input power value of I₂ and the input amplitude value of I₁, i.e., Δ21=I₂−I₁. It can be observed from the graph 420 that the input power values of I₀, I₁ and I₂ are equidistant, i.e., Δ10=Δ21.

FIG. 4C illustrates an example graph 430 of an output power generated over time by the nonlinear photonic circuit 110 having the gain function 402, in accordance with some embodiments. The graph 430 shows different output power values that are associated with output amplitude values generated over time by the nonlinear photonic circuit 110 while operating in different operating regimes (or different regions, such as the regions 405 and 410 in FIG. 4A). Specifically, the graph 430 shows the output power values having three different values of O₀, O₁ and O₂ generated by the nonlinear photonic circuit 110 when the respective input power values of I₀, I₁ and I₂ are applied to the nonlinear photonic circuit 110. Furthermore, the output power values O₀, O₁ and O₂ may be also associated with output amplitudes in FIG. 3C and FIG. 3D when input amplitudes of levels “0”, “1” and “2” are respectively applied to the nonlinear photonic circuit 110.

The value Δ′10 in FIG. 4C represents a difference between the output power value of O₁ and the output power value of O₀, i.e., Δ′10=O₁−O₀. Similarly, the value Δ′21 in FIG. 4C represents a difference between the output power value of O₂ and the output power value of O₁, i.e., Δ′21=O₂−O₁. It can be observed from the graph 430 that the output power values of O₀, O₁ and O₂ are not equidistant for the equidistant input power values of I₀, I₁ and I₂, i.e., Δ′10 >Δ′21 although Δ10=Δ21. When the nonlinear photonic circuit 110 operates in the nonlinear operating regime (e.g., in the region 410, also referred to as the “saturation region” or the “nonlinear operating region”), a smaller gain (e.g., gain of G₂ in FIG. 4A) is applied to the higher input power value of I₂ and a higher gain (e.g., gain of G₁ in FIG. 4A) is applied to the lower input power value of I₁. Thus, the result of the nonlinear operating regime is that the output power value of O₂ is closer to the output power value of O₁ than the output power value of O₁ is to the output power value of O₀, i.e., the output amplitudes generated by the nonlinear photonic circuit 110 are saturated when the nonlinear photonic circuit 110 operates in the nonlinear operating regime (e.g., in the region 410).

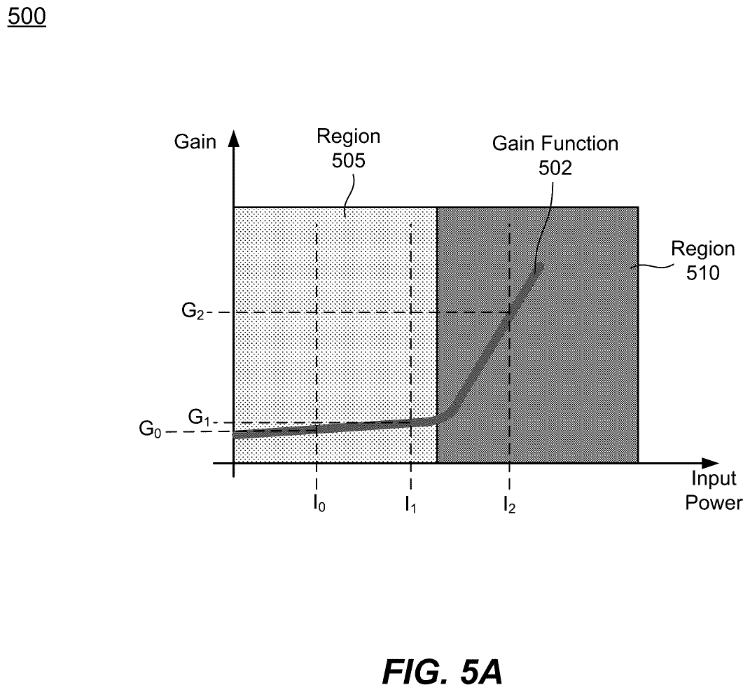

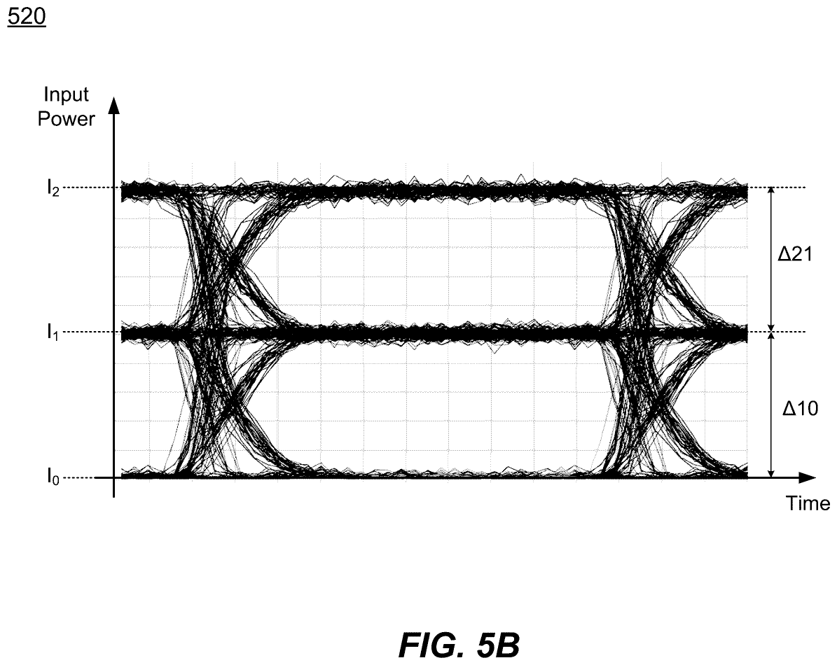

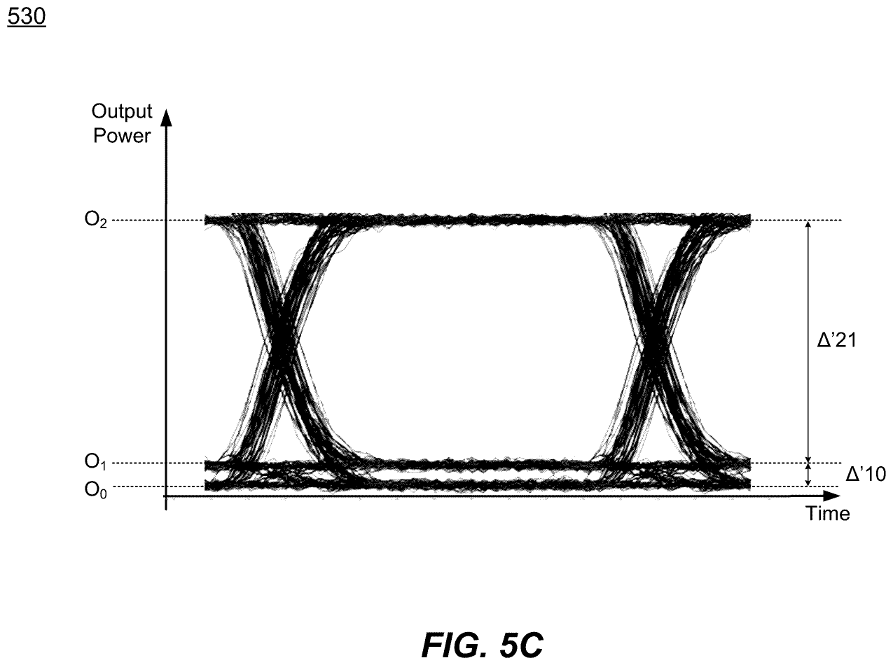

FIG. 5A illustrates an example graph 500 of a gain function 502 of the nonlinear photonic circuit 110, in accordance with some embodiments. The gain function 502 defines the relation between an input power of the nonlinear photonic circuit 110 and a gain applied by the nonlinear photonic circuit 110 to amplitudes of the one or more photonic signals 104₁, . . . , 104_{P} input to the nonlinear photonic circuit 110 (i.e., “input amplitudes”) to generate amplitudes of the one or more photonic output signals 106₁, . . . , 106_{N} (i.e., “output amplitudes”). It can be observed from the graph 500 that a gain applied by the nonlinear photonic circuit 110 differs for different operating regions (i.e., different operating regimes) of the nonlinear photonic circuit 110. In one or more embodiments, the gain function 502 is obtained by implementing the nonlinear photonic circuit 110 as the nonlinear photonic circuit 255 of FIG. 2A, i.e., as a cascading connection of a first SOA, a saturable absorber, and a second SOA.

When the nonlinear photonic circuit 110 operates in a region 505, the gain may vary between a lower bound and an upper bound, where a difference between the upper bound and the lower bound is less than a threshold value (which corresponds to “saturation region”, “nonlinear operating region” or “nonlinear operating regime”). Alternatively, the region 505 may correspond to the “linear operating regime” and the gain is constant, i.e., the difference between the upper bound and the lower bound is zero. When any of the one or more photonic signals 104₁, . . . , 104_{P} is applied to the nonlinear photonic circuit 110 having an input amplitude with an input power of I₀ that falls within the region 505, a gain of G₀ is applied to the input amplitude. And, when any of the one or more photonic signals 104₁, . . . , 104_{P} is applied to the nonlinear photonic circuit 110 having an input amplitude with an input power of I₁>I₀ that falls within the region 505, a gain of G₁≥G₀ is applied to the input amplitude. When the nonlinear photonic circuit 110 operates in a region 510 (i.e., “saturation region”, “nonlinear operating region” or “nonlinear operating regime”), the gain function 502 is an increasing function of the input power. Thus, when the nonlinear photonic circuit 110 operates in the region 510, a gain of G₂>G₁ is applied to an input amplitude having an input power of I₂>I₁.

FIG. 5B illustrates an example graph 520 of an input power applied over time to the nonlinear photonic circuit 110 having the gain function 502, in accordance with some embodiments. The graph 520 shows different input power values that are proportional to input amplitude values applied over time to the nonlinear photonic circuit 110 while operating the nonlinear photonic circuit 110 in different operating regimes (or different regions, such as the regions 505 and 510 in FIG. 5A). Specifically, the graph 520 shows the input power values having three different values of I₀, I₁ and I₂ that may correspond respectively to the input power values I₀, I₁ and I₂ in FIG. 5A. Furthermore, the input power values I₀, I₁ and I₂ may also correspond respectively to the input amplitudes of levels “0”, “1” and “2” in FIG. 3A. The value Δ10 in FIG. 5B represents a difference between the input power value of I₁ and the input power value of I₀, i.e., Δ10=I₁−I₀. Similarly, the value 421 in FIG. 5B represents a difference between the input power value of I₂ and the input amplitude value of I₁, i.e., Δ21=I₂−I₁. It can be observed from the graph 520 that the input power values of I₀, I₁ and I₂ are equidistant, i.e., Δ10=Δ21.

FIG. 5C illustrates an example graph 530 of an output power generated over time by the nonlinear photonic circuit 110 having the gain function 502, in accordance with some embodiments. The graph 530 shows different output power values that are associated with output amplitude values generated over time by the nonlinear photonic circuit 110 while operating in different operating regimes (or different regions, such as the regions 505 and 510 in FIG. 5A). Specifically, the graph 530 shows the output power values having three different values of O₀, O₁ and O₂ generated by the nonlinear photonic circuit 110 when the respective input power values of I₀, I₁ and I₂ are applied to the nonlinear photonic circuit 110. Furthermore, the output power values O₀, O₁ and O₂ may also correspond to output amplitudes in FIG. 3A when input amplitudes of levels “0”, “1” and “2” are respectively applied to the nonlinear photonic circuit 110.

The value Δ′10 in FIG. 5C represents a difference between the output power value of O₁ and the output power value of O₀, i.e., Δ′10=O₁−O₀. Similarly, the value Δ′21 in FIG. 5C represents a difference between the output power value of O₂ and the output power value of O₁, i.e., Δ′21=O₂−O₁. It can be observed from the graph 530 that the output power values of O₀, O₁ and O₂ are not equidistant for the equidistant input power values of I₀, I₁ and I₂, i.e., Δ′10 <Δ′21 although Δ10=Δ21. When the nonlinear photonic circuit 110 operates in the region 505, a gain applied to the input power value of I₁ (e.g., the gain of G₁) may be only marginally greater than (or even same) as a gain applied to the input power value of I₀ (e.g., the gain of G₀). And, when the nonlinear photonic circuit 110 operates in the region 510, a larger gain of G₂ is applied to the input power of I₂, where G₁−G₀<G₂−G₁. Because of that, the result of the nonlinear photonic circuit 110 operating in the regions 505, 510 is that the output power value of O₁ is closer to the output power value of O₀ than the output power value of O₁ is to the output power value of O₂. Hence, the output amplitudes generated by the nonlinear photonic circuit 110 when the nonlinear photonic circuit 110 operates in the region 505 are saturated by applying the floor ceiling to the input amplitudes.

In one or more embodiments, any configuration of the nonlinear photonic circuit 110 in FIG. 2A can be utilized to change the spacing between amplitude levels generated by the nonlinear photonic circuit 110, i.e., the values of Δ10 and/or Δ21 can be changed at the output of the nonlinear photonic circuit 110 into different values of Δ′10 and/or Δ′21. It should be also noted that although FIGS. 4A-4C and FIGS. 5A-5C illustrate scenarios with three different input/output amplitude levels, different number of input/output amplitude levels are possible, such as two input/output amplitude levels or more than three input/output amplitude levels.

### Example Process Flow

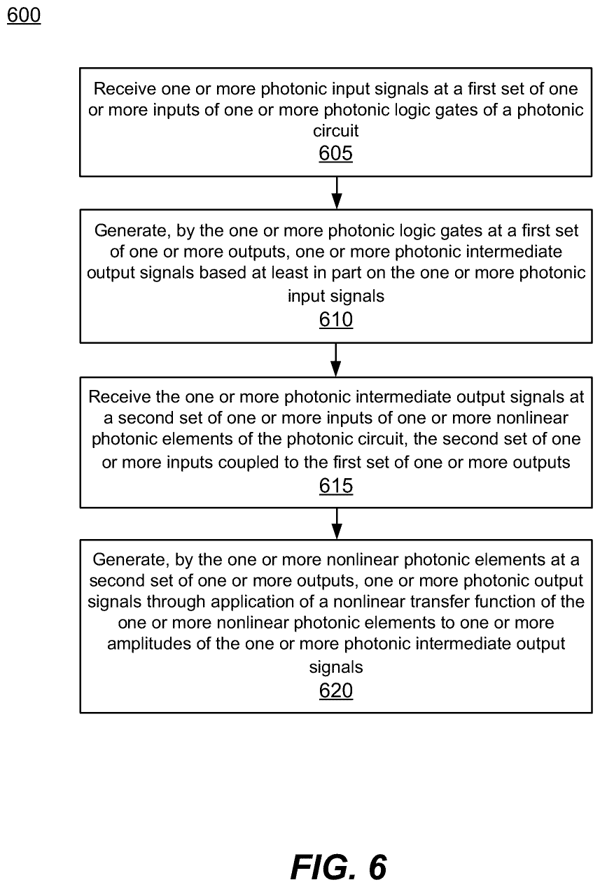

FIG. 6 is a flowchart illustrating an example method 600 for operating a photonic circuit as a hybrid photonic gate, in accordance with some embodiments. The operations of method 600 may be performed at, e.g., the photonic circuit 100. The photonic circuit may be part of a photonic processor that includes the photonic circuit 100 and one or more additional photonic circuits including the photonic circuit 100 (i.e., cascading connection of at least two of the photonic circuits 100). The photonic circuit 100 may be deployed in a computing system (e.g., photonic processor, electronic processor, some other type of processor, or some combination thereof) that can further include a non-transitory computer-readable storage medium (e.g., optical, electrical, or electro-optical memory) for storing computer-executable instructions and data. The computing system may be an optical computing system (i.e., silicon photonics platform), an electronic computing system, some other type of computing system, or some combination thereof.

The photonic circuit receives 605 one or more photonic input signals (e.g., the one or more photonic input signals 102₁, . . . , 102_{M}) at a first set of one or more inputs of one or more photonic logic gates (e.g., the photonic logic gate 105) of the photonic circuit. The photonic circuit generates 610, by the one or more photonic logic gates at a first set of one or more outputs, one or more photonic intermediate output signals (e.g., the one or more photonic signals 104₁, . . . , 104_{P}) based at least in part on the one or more photonic input signals. The one or more photonic logic gates may be composed of one or more linear photonic elements.

The photonic circuit receives 615 the one or more photonic intermediate output signals at a second set of one or more inputs of one or more nonlinear photonic elements (e.g., the nonlinear photonic circuit 110) of the photonic circuit, the second set of one or more inputs coupled to the first set of one or more outputs. The photonic circuit generates 620, by the one or more nonlinear photonic elements at a second set of one or more outputs, one or more photonic output signals (e.g., the one or more photonic output signals 106₁, . . . , 106_{N}) through application of a nonlinear transfer function of the one or more nonlinear photonic elements to one or more amplitudes of the one or more photonic intermediate output signals.

The one or more nonlinear photonic elements may include one or more amplitude thresholders configured to apply the nonlinear transfer function by saturating the one or more amplitudes of the one or more photonic intermediate output signals to one or more amplitude saturation levels when generating the one or more photonic output signals. One or more differences between two or more amplitude levels of the one or more photonic output signals (e.g., amplitude levels of the one or more photonic output signals 106₁, . . . , 106_{N}) generated by the one or more nonlinear photonic elements (e.g., the nonlinear photonic circuit 110) may be smaller than one or more differences between two or more amplitude levels of the one or more photonic intermediate output signals (e.g., amplitude levels of the one or more photonic signals 104₁, . . . , 104_{P}) input to the one or more nonlinear photonic elements. The one or more differences between the two or more amplitude levels of the one or more photonic output signals may depend on the nonlinear transfer function of the one or more nonlinear photonic elements.

The one or more nonlinear photonic elements may operate in at least one of: a first operating regime defined by a first portion of the nonlinear transfer function, a second operating regime defined by a second portion of the nonlinear transfer function, and a third operating regime defined by a third portion of the nonlinear transfer function. The one or more nonlinear photonic elements may be configured to operate in the first operating regime, the second operating regime, or the third operating regime based on each amplitude of the one or more photonic intermediate output signals. The one or more nonlinear photonic elements may be configured to: saturate an amplitude of the one or more photonic intermediate output signals to a first amplitude level, when the one or more nonlinear photonic elements operate in the first operating regime; apply a transfer gain of the nonlinear transfer function to the amplitude of the one or more photonic intermediate output signals, when the one or more nonlinear photonic elements operate in the second operating regime; or saturate the amplitude of the one or more photonic intermediate output signals to a second amplitude level, when the one or more nonlinear photonic elements operate in the third operating regime. A difference between the first amplitude level and the second amplitude level may depend on a configuration of the one or more nonlinear photonic elements.

In one or more embodiments, the one or more nonlinear photonic elements (e.g., the nonlinear photonic circuits 210, 240 and/or 255) include one or more active SOA-based amplitude thresholders. In one or more other embodiments, the one or more nonlinear photonic elements (e.g., the nonlinear photonic circuits 200, 210, 240, and/or 255) include a saturable absorber. The one or more nonlinear photonic elements may further include one or more SOAs coupled to the saturable absorber. The one or more SOAs may be configured to operate in one or more linear operating regimes and amplify one or more photonic signals input to the one or more SOAs. The nonlinear transfer function of the one or more nonlinear photonic elements may correspond to a nonlinear transfer function of the saturable absorber.

In one or more other embodiments, the one or more nonlinear photonic elements (e.g., the nonlinear photonic circuit 255) include a first SOA (e.g., the first SOA 260) having a first input and a first output, a saturable absorber (e.g., the saturable absorber 265) having a second input and a second output, and a second SOA (e.g., the second SOA 270) having a third input and a third output. The first input of the first SOA may be coupled to the first set of one or more outputs (e.g., the set of one or more outputs of the photonic logic gate 105) and configured to receive the one or more photonic intermediate output signals (e.g., the one or more photonic signals 104₁, . . . , 104_{P}). The second input of the saturable absorber may be coupled to the first output of the first SOA, and the third input of the second SOA may be coupled to the second output of the saturable absorber. The second SOA (e.g., the second SOA 270) may output the one or more photonic output signals (e.g., the one or more photonic output signals 106₁, . . . , 106_{N}) at the third output. The nonlinear transfer function of the one or more nonlinear photonic elements may be a cumulative transfer function of the first SOA, the saturable absorber and the second SOA.

This disclosure presents various configurations of nonlinear photonic elements for realization of error-free hybrid photonic circuits. The nonlinear photonic elements presented herein can include one or more saturable absorbers, one or more SOA-based amplitude thresholders, or some combination thereof. By employing a specific combination of saturable absorbers and/or SOAs, different nonlinear transfer functions can be realized.

### Additional Considerations

The disclosed configurations beneficially provide for efficient design of photonic logic gates while substantially reducing a number of required numerical design simulations. Moreover, the circuits noted may be designed and simulated with electronic, electronic-photonic and/or photonic design automation tools (referred to herein as “design automation”) and represented as circuit layouts stored in an electronic library, electronic-photonic library and/or photonic library. The circuit designs may be retrieved and incorporated into designs of chips including the retrieved design.

The design automation may include a set of processes used during the design, verification, and fabrication of an article of manufacture such as an integrated circuit (e.g., photonic integrated circuit) to transform and verify design data and instructions that represent the integrated circuit. Each of these processes can be structured and enabled as multiple modules or operations. These processes may start with the creation of a product idea with information supplied by a designer, information which is transformed to create an article of manufacture that uses a set of design automation processes. When the design is finalized, the design can be taped-out, which is when artwork (e.g., geometric patterns) for the integrated circuit is sent to a fabrication facility to manufacture the mask set, which is then used to manufacture the integrated circuit. After tape-out, a die (e.g., photonic die) is fabricated and packaging and assembly processes are performed to produce the finished integrated circuit.

During system design as part of design automation, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification as part of design automation, modules or components in the integrated circuit are specified in one or more description languages and the specification is checked for functional accuracy. For example, the components of the integrated circuit may be verified to generate outputs that match the requirements of the specification of the integrated circuit or system being designed. Functional verification may use simulators and other programs such as testbench generators, static hardware description language (‘HDL’) checkers, and formal verifiers. In some embodiments, special systems of components referred to as ‘emulators’ or ‘prototyping systems’ are used to speed up the functional verification. During design planning as part of design automation, an overall floor plan for the integrated circuit is constructed and analyzed for timing and top-level routing.

During layout or physical implementation as part of design automation, physical placement (positioning of circuit components) and routing (connection of the circuit components) occurs, and the selection of cells from a library to enable specific logic functions can be performed. As used herein, the term ‘cell’ may specify a set of components and interconnections that provides a Boolean logic function (e.g., AND, OR, NOT, XOR, etc.) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by design automation products.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to effectively convey the substance of their work to others skilled in the art. While described functionally, computationally, or logically, these operations are understood to be implemented by computer programs or equivalent electrical circuits, microcode, or the like. Furthermore, at times, it has also proven convenient to refer to these arrangements of operations as modules without loss of generality. The described operations and associated modules can be embodied in software, firmware, hardware, or some combination thereof.

Any steps, operations, or processes described herein can be performed or implemented with one or more hardware or software modules, alone or in combination with other devices. In one embodiment, a software module is implemented with a computer program product comprising a computer-readable medium containing computer program code, which a computer processor can execute for performing any or all of the steps, operations, or processes described herein.

Embodiments of the disclosure can also relate to an apparatus for performing the operations herein. This apparatus can be specially constructed for the required purposes, and/or it can comprise a general-purpose computing device selectively activated or reconfigured by a computer program stored in the computer. Such a computer program can be stored in a non-transitory, tangible computer-readable storage medium or any media suitable for storing electrical instructions coupled to a computer system bus. Furthermore, any computing systems referred to in the specification can include a single processor or architectures employing multiple processor designs for increased computing capability.

Some embodiments of the present disclosure can further relate to a system comprising a processor, at least one computer processor, and a non-transitory computer-readable storage medium. The storage medium can store computer-executable instructions, which, when executed by the compiler operating on at least one computer processor, cause at least one computer processor to be operable for performing the operations and techniques described herein.

Finally, the language used in the specification has been principally selected for readability and instructional purposes, and it has not been selected to delineate or circumscribe the inventive subject matter. It is therefore intended that the scope of the disclosure be limited not by this detailed description but rather by any claims that issue on an application based hereon. Accordingly, the disclosure of the embodiments is intended to be illustrative, but not to limit the scope of the disclosure, which is set forth in the following claims.

What is claimed is:

1. A photonic circuit, comprising:
one or more photonic logic gates having a first set of one or more inputs and a first set of one or more outputs, the first set of one or more inputs configured to receive one or more photonic input signals, the one or more photonic logic gates configured to generate one or more photonic intermediate output signals at the first set of one or more outputs based at least in part on the one or more photonic input signals; and
one or more nonlinear photonic elements having a second set of one or more inputs and a second set of one or more outputs, the second set of one or more inputs coupled to the first set of one or more outputs and configured to receive the one or more photonic intermediate output signals, the one or more nonlinear photonic elements configured to generate one or more photonic output signals at the second set of one or more outputs through application of a nonlinear transfer function of the one or more nonlinear photonic elements to one or more amplitudes of the one or more photonic intermediate output signals.

2. The photonic circuit of claim 1, wherein the one or more nonlinear photonic elements comprise one or more amplitude thresholders configured to apply the nonlinear transfer function by saturating the one or more amplitudes of the one or more photonic intermediate output signals to one or more amplitude saturation levels when generating the one or more photonic output signals.

3. The photonic circuit of claim 1, wherein one or more differences between two or more amplitude levels of the one or more photonic output signals generated by the one or more nonlinear photonic elements are smaller than one or more differences between two or more amplitude levels of the one or more photonic intermediate output signals input to the one or more nonlinear photonic elements.

4. The photonic circuit of claim 3, wherein the one or more differences between the two or more amplitude levels of the one or more photonic output signals depend on the nonlinear transfer function of the one or more nonlinear photonic elements.

5. The photonic circuit of claim 1, wherein the one or more nonlinear photonic elements operate in at least one of: a first operating regime defined by a first portion of the nonlinear transfer function, a second operating regime defined by a second portion of the nonlinear transfer function, and a third operating regime defined by a third portion of the nonlinear transfer function.

6. The photonic circuit of claim 5, the one or more nonlinear photonic elements are configured to operate in the first operating regime, the second operating regime, or the third operating regime based on each amplitude of the one or more photonic intermediate output signals.

7. The photonic circuit of claim 1, wherein the one or more nonlinear photonic elements are configured to:
saturate an amplitude of the one or more photonic intermediate output signals to a first amplitude level, when the one or more nonlinear photonic elements operate in the first operating regime,
apply a transfer gain of the nonlinear transfer function to the amplitude of the one or more photonic intermediate output signals, when the one or more nonlinear photonic elements operate in the second operating regime, or
saturate the amplitude of the one or more photonic intermediate output signals to a second amplitude level, when the one or more nonlinear photonic elements operate in the third operating regime.

8. The photonic circuit of claim 7, wherein a difference between the first amplitude level and the second amplitude level depends on a configuration of the one or more nonlinear photonic elements.

9. The photonic circuit of claim 1, wherein the one or more nonlinear photonic elements comprise one or more active semiconductor optical amplifier-based amplitude thresholders.

10. The photonic circuit of claim 1, wherein the one or more nonlinear photonic elements comprise a saturable absorber.

11. The photonic circuit of claim 10, wherein the one or more nonlinear photonic elements further comprise one or more semiconductor optical amplifiers (SOAs) coupled to the saturable absorber.

12. The photonic circuit of claim 11, wherein the one or more SOAs are configured to operate in one or more linear operating regimes and amplify one or more photonic signals input to the one or more SOAs, and the nonlinear transfer function is a nonlinear transfer function of the saturable absorber.

13. The photonic circuit of claim 1, wherein the one or more nonlinear photonic elements comprise:
a first semiconductor optical amplifier (SOA) having a first input and a first output, the first input coupled to the first set of one or more outputs and configured to receive the one or more photonic intermediate output signals;
a saturable absorber having a second input and a second output, the second input coupled to the first output of the first SOA; and
a second SOA having a third input and a third output, the third input coupled to the second output of the saturable absorber, the second SOA configured to output the one or more photonic output signals at the third output.

14. The photonic circuit of claim 13, wherein the nonlinear transfer function is a cumulative transfer function of the first SOA, the saturable absorber and the second SOA.

15. The photonic circuit of claim 1, wherein the one or more photonic logic gates are composed of one or more linear photonic elements.

16. The photonic circuit of claim 1, wherein the photonic circuit is part of a photonic processor comprising the photonic circuit and one or more other photonic circuits, one or more inputs of the one or more other photonic circuits coupled to the second set of one or more outputs of the photonic circuit.

17. A non-transitory computer-readable storage medium comprising stored instructions that, when executed by at least one processor, cause the at least one processor to execute operations comprised to:
instruct one or more photonic logic gates of a photonic circuit to receive one or more photonic input signals at a first set of one or more inputs;
instruct the one or more photonic logic gates to generate one or more photonic intermediate output signals at a first set of one or more outputs based at least in part on the one or more photonic input signals;
instruct one or more nonlinear photonic elements of the photonic circuit to receive the one or more photonic intermediate output signals at a second set of one or more inputs coupled to the first set of one or more outputs; and
instruct the one or more nonlinear photonic elements to generate one or more photonic output signals at a second set of one or more outputs through application of a nonlinear transfer function of the one or more nonlinear photonic elements to one or more amplitudes of the one or more photonic intermediate output signals.

18. The computer-readable storage medium of claim 17, wherein the stored instructions comprise further stored instructions that, when executed, cause the at least one processor to:
instruct one or more amplitude thresholders of the one or more nonlinear photonic elements to apply the nonlinear transfer function by saturating the one or more amplitudes of the one or more photonic intermediate output signals to one or more amplitude saturation levels when generating the one or more photonic output signals.

19. The computer-readable storage medium of claim 17, wherein the stored instructions comprise further stored instructions that, when executed, cause the at least one processor to:
instruct the one or more nonlinear photonic elements to generate of the one or more photonic output signals so that one or more differences between two or more amplitude levels of the one or more photonic output signals are smaller than one or more differences between two or more amplitude levels of the one or more photonic intermediate output signals input to the one or more nonlinear photonic elements, the one or more differences between the two or more amplitude levels of the one or more photonic output signals depend on the nonlinear transfer function of the one or more nonlinear photonic elements.

20. A method comprising:
receiving one or more photonic input signals at a first set of one or more inputs of one or more photonic logic elements of a photonic circuit;
generating, by the one or more photonic logic elements at a first set of one or more outputs, one or more photonic intermediate output signals based at least in part on the one or more photonic input signals;
receiving the one or more photonic intermediate output signals at a second set of one or more inputs of one or more nonlinear photonic elements of the photonic circuit, the second set of one or more inputs coupled to the first set of one or more outputs; and
generating, by the one or more nonlinear photonic elements at a second set of one or more outputs, one or more photonic output signals through application of a nonlinear transfer function of the one or more nonlinear photonic elements to one or more amplitudes of the one or more photonic intermediate output signals.
